(19) United States
(12) Patent Application Publication
(10) Pub. No.: US 2025/0259776 A1
(43) Pub. Date: Aug. 14, 2025

(54) POWER INDUCTOR

(71) Applicant: CHILISIN ELECTRONICS CORP., Taoyuan City (TW)

(72) Inventors: Jui-Min CHUNG, Taoyuan City (TW); Ming-Chieh CHIU, Taoyuan City (TW); Min-Zhen SUN, Taoyuan City (TW); Shin-Shiang HUANG, Taoyuan City (TW)

(21) Appl. No.: 19/196,762

(22) Filed: May 2, 2025

Related U.S. Application Data
(63) Continuation-in-part of application No. 18/977,973, filed on Dec. 12, 2024.
(60) Provisional application No. 63/614,630, filed on Dec. 25, 2023.

(30) Foreign Application Priority Data
Apr. 17, 2024 (TW) 113114297

(51) Int. Cl. H01F 27/255; H01F 27/28; H01F 27/32

(52) U.S. Cl. CPC H01F 27/255; H01F 27/324; H01F 27/2804

(57) ABSTRACT

A power inductor includes a coil and an induced magnetic element. The coil includes two outer loop circuit layers and a plurality of insulation spacing layer. The outer loop circuit layers are stacked up and electrically connected to each other. The outer loop circuit layers have an outer connection end apiece. At least one insulation spacing layer is located between the outer loop circuit layers. The induced magnetic element encapsulates the coil and exposes the outer connection end of each of the outer loop circuit layers. The induced magnetic element includes a plurality of ferromagnetic particles. The ferromagnetic particles include an iron-based alloy particle and an insulation film covering the iron-based alloy particle apiece.

### RELATED APPLICATIONS

This application is a Continuation-in-part of U.S. application Ser. No. 18/977,973, filed on Dec. 12, 2024, which claims priority of U.S. Provisional Application Ser. No. 63/614,630, filed on Dec. 25, 2023, and Taiwan Application Serial Number 113114297, filed Apr. 17, 2024, the entirety of which is incorporated by reference herein in their entireties.

### BACKGROUND

### Field of Invention

The present disclosure relates to an electronic component, and more particularly, to a power inductor.

### Description of Related Art

Most of general power inductors have the issue of low insulation resistance, so that the short circuit is prone to occurring in high current and voltage circuits, such as automotive circuits and high-power circuits for electronics. As a result, the aforementioned power inductors abnormally function or even permanently fail.

### SUMMARY

Therefore, one objective of the present disclosure is to provide a power inductor, which has a higher insulation resistance.

An aspect of the present disclosure provides a power inductor including a coil, including two outer loop circuit layers stacked up and electrically connected to each other and a plurality of insulation spacing layers. Each of the outer loop circuit layers has an outer connection end. At least one of the insulation spacing layers is located between the outer loop circuit layers. An induced magnetic element encapsulates the coil and exposing the outer connection end of each of the outer loop circuit layers, where the induced magnetic element has a plurality of ferromagnetic particles. Each of the ferromagnetic particles includes an iron-based alloy particle and an insulation film covering the iron-based alloy particle.

In accordance with one embodiment of the invention, one of the outer loop circuit layers is located between two insulation spacing layers adjacent to each other.

In accordance with one embodiment of the invention, the power inductor further includes a plurality of external electrodes partially covering an outer surface of the induced magnetic element and connected to the outer connection ends of the outer loop circuit layers.

In accordance with one embodiment of the invention, the coil further includes an inner loop circuit layer disposed between the outer loop circuit layers and electrically connected to the outer loop circuit layers, where the inner loop circuit layer is located between two of the insulation spacing layers.

In accordance with one embodiment of the invention, each of the outer loop circuit layers has a first inner connection end opposite to the outer connection end, and the inner loop circuit layer has two second inner connection ends opposite to each other. The first inner connection end of each of the outer loop circuit layers is connected to one of the second inner connection ends.

In accordance with one embodiment of the invention, each of the insulation spacing layers is a strip, and two of the insulation spacing layers cover and directly touch the outer loop circuit layers and extend along with the outer loop circuit layers separately. Each of the insulation spacing layers has a pair of first side walls opposite to each other, and the two of the insulation spacing layers separately extending along with the outer loop circuit layers protrude from the first side walls of the outer loop circuit layers separately.

In accordance with one embodiment of the invention, the first connection end of one of the outer loop circuit layers protrudes from an end of one of the insulation spacing layers.

In accordance with one embodiment of the invention, one of the insulation spacing layer directly touches and extends along with the inner loop circuit layer. The inner loop circuit layer has a pair of second side walls opposite to each other, and the insulation spacing layer extending along with the inner loop circuit layer protrudes from the second side walls.

In accordance with one embodiment of the invention, one of the second inner connection ends of the inner loop circuit layer protrudes from the end of the insulation spacing layer extending along with the inner loop circuit layer.

In accordance with one embodiment of the invention, each of the insulation spacing layers protrudes from an edge of any one of the outer loop circuit layers.

In accordance with one embodiment of the invention, the power inductor further includes a plurality of covering layers covering two opposite side of the induced magnetic element and the coil separately, and the plurality of covering layers directly touch the induced magnetic element.

In accordance with one embodiment of the invention, the plurality of covering layers cover the outer loop circuit layers and at least one of the insulation spacing layers.

In accordance with one embodiment of the invention, the insulation film is an oxide film including silicon dioxides.

In accordance with one embodiment of the invention, the dimensions of the plurality of ferromagnetic particles are identical.

In accordance with one embodiment of the invention, the outer loop circuit layers are strips.

Based on the above, the insulation spacing layers can effectively improve the insulation resistance between the outer loop circuit layer and the inner loop circuit layer, so as to prevent from the short circuit. Therefore, it is advantage for the power inductors to be utilized in high current and voltage circuits, such as automotive circuits and high power circuits for electronics.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1A is a schematic top view of a power inductor in accordance with one embodiment of the present disclosure.

FIG. 1B is a schematic top view of a power inductor in FIG. 1A without external electrodes.

FIG. 1C is a schematic cross-sectional view along with the line 1C-1C of FIG. 1A.

FIG. 1D is a locally-magnified schematic cross-sectional view of the induced magnetic element in FIG. 1C.

FIG. 1E is a locally-magnified schematic cross-sectional view of the insulation spacing layers in FIG. 1C.

FIG. 1F is a locally-magnified schematic cross-sectional view of the covering layers in FIG. 1C.

FIG. 1G is a schematic cross-sectional view along with the line 1G-1G of FIG. 1A.

FIG. 2A to FIG. 2C, FIG. 3A to FIG. 3B and FIG. 4A to FIG. 4C are schematic cross-sectional views of a method for fabricating a power inductor in accordance with one embodiment of the present disclosure.

FIG. 5 is a schematic cross-sectional view of a power inductor in accordance with one embodiment of the present disclosure.

### DETAILED DESCRIPTION

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

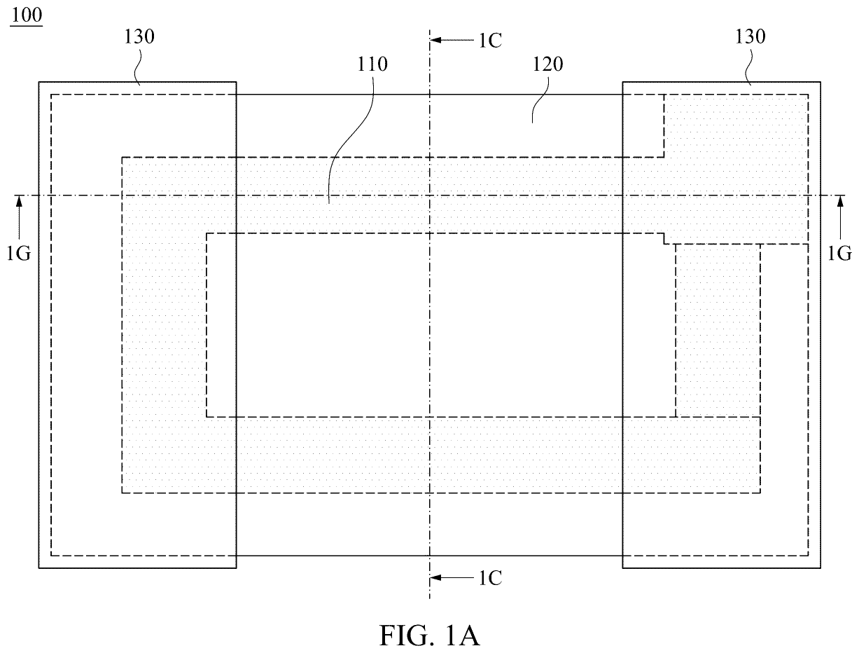

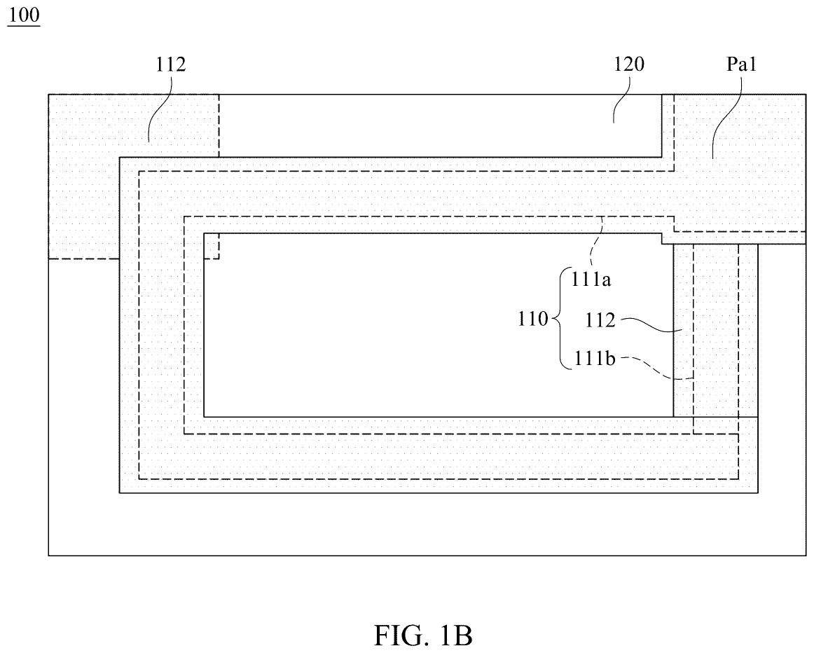

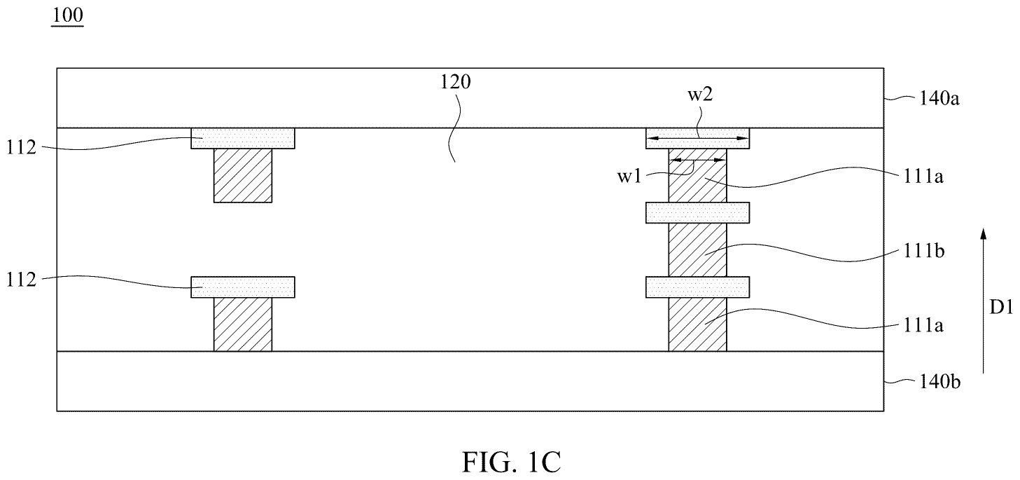

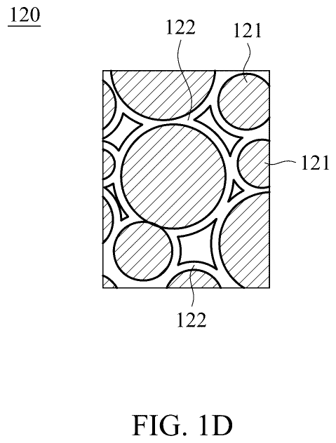

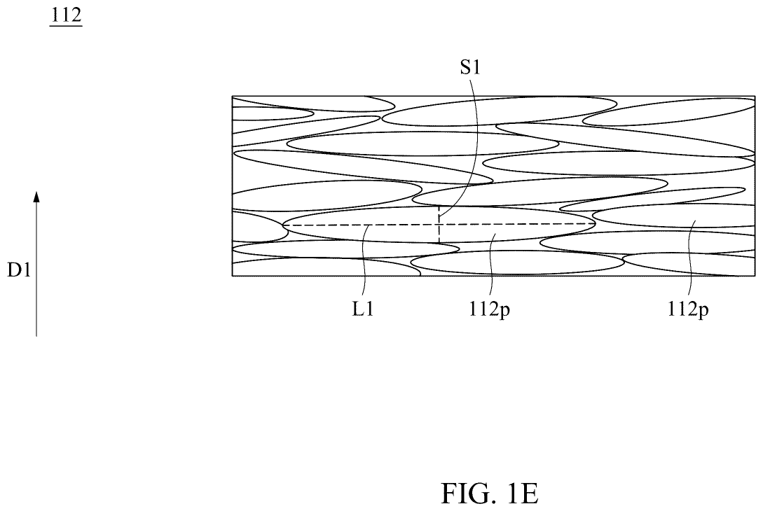

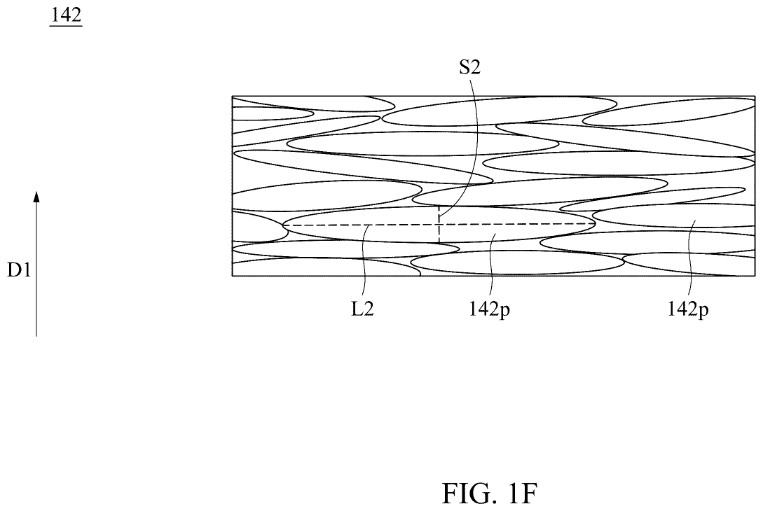

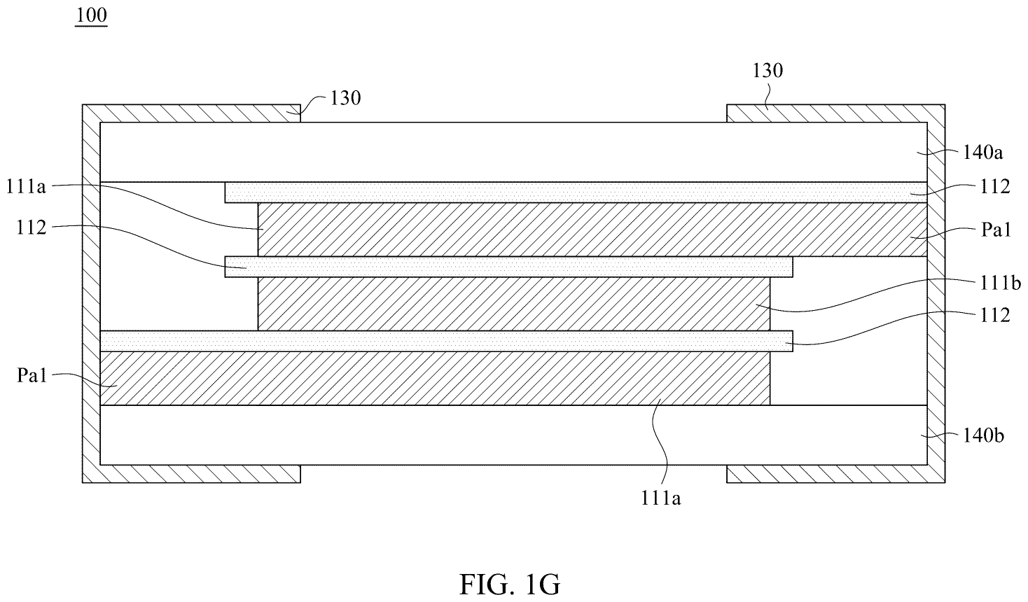

FIG. 1A is a schematic top view of a power inductor in accordance with at least one embodiment of the present disclosure. Referring to FIG. 1A, a power inductor 100 includes a coil 110, an induced magnetic element 120 and a plurality of external electrodes 130. The induced magnetic element 120 encapsulates the coil 110. These external electrodes 130 partially cover the outer surface of the induced magnetic element 120 and are connected to the coil 110. As shown in FIG. 1A, the external electrodes 130 may separately cover the side surfaces on the left and the right sides of the induced magnetic element 120, so that the external electrodes 130 cover a part of the outer surface of the induced magnetic element 120 instead of covering the whole outer surface of the induced magnetic element 120.

FIG. 1B is a schematic top view of a power inductor in FIG. 1A without the external electrodes, while FIG. 1C is a schematic cross-sectional view along with the line 1C-1C of FIG. 1A. Referring to FIG. 1B and FIG. 1C, the coil 110 includes two outer loop circuit layers 111a, at least one inner loop circuit layer 111b and a plurality of insulation spacing layers 112. The insulation spacing layers 112 may be such as ceramic and/or glass material layers or ferromagnetism materials, while the materials of the outer loop circuit layers 111a and the inner loop circuit layer 111b may be copper, silver, gold or alloy.

The inner loop circuit layer 111b is disposed between the outer loop circuit layers 111a. These two outer loop circuit layers 111a are stacked up and electrically connected to each other. For instance, the inner loop circuit layer 111b is electrically connected to the outer loop circuit layers 111a, so that the outer loop circuit layers 111a are electrically connected to each other through the inner loop circuit layer 111b. It is worth mentioning, these two outer loop circuit layers 111a are stacked up and electrically connected to each other in the thickness direction D1. In addition, in this embodiment, at least one of the insulation spacing layers 112 is located between the outer loop circuit layers 111a, while one of the outer loop circuit layers 111a is located between two insulation spacing layers 112 which are adjacent to each other.

As shown in FIG. 1C, the upper outer loop circuit layer 111a is located between two insulation spacing layers 112 which are adjacent to each other. However, the insulation spacing layers 112 only cover the upper surface of the lower outer loop circuit layer 111a but the lower surface of the outer loop circuit layer 111a, that is, the lower surface of the outer loop circuit layer 111a is not covered by any of the insulation spacing layers 112. Further, the inner loop circuit layer 111b is located between two of the insulation spacing layers 112, so that these two insulation spacing layers 112 are located between the outer loop circuit layers 111a.

However, in other embodiments, each of the outer loop circuit layers 111a may not be located between the insulation spacing layers 112 which are adjacent to each other. For instance, the top insulation spacing layer may be omitted, so that the upper surface of the upper outer loop circuit layer 111a is not covered by the insulation spacing layer 112 in FIG. 1C. Thus, the induced magnetic element 120 exposes the upper surface of the upper outer loop circuit layer 111a and exposes the lower surface of the lower outer loop circuit layer 111a. In other words, the induced magnetic element 120 may not cover the upper surface of the upper outer loop circuit layer 111a and the lower surface of the lower outer loop circuit layer 111a.

It is worth mentioning that the upper outer loop circuit layer 111a and the inner loop circuit layer 111b has a width w1 apiece, while the insulation spacing layer 112 has a width w2 (as shown in FIG. 1C). In various embodiments, the width w1 of the upper outer loop circuit layer 111a may be less than or equal to the width w2 of the insulation spacing layer. That is, the width w1 and the width w2 follow the equation: w2−w1≥0 μm.

Each of the outer loop circuit layers 111a has an outer connection end Pa1 which is substantially a pad and is utilized to electrically connected to the external electrodes 130 (shown in FIG. 1A), so as to input the external electricity into the outer connection end Pa1 through the external electrodes 130. As a result, the power inductor 100 may work, and thereby the circuit which is equipped with the power inductor 100 (e.g., the automobile circuit or the high power circuit for an electronic) may be functioned.

It is worth mentioning that the power inductor 100 includes two outer loop circuit layers 111a, while each of the outer loop circuit layers 111a has at least one outer connection end Pa1, so that the power inductor 100 may have at least two outer connection ends Pa1. Moreover, in the embodiment shown in FIG. 1B, the outer connection end Pal on the left is covered by the rectangular insulation spacing layer 112 on the left, so that only one outer connection end Pa1 is illustrated in FIG. 1B.

Furthermore, it should be noted that the power inductor 100 includes the inner loop circuit layer 111b in this embodiment, so that the power inductor 100 has three circuit layers, namely, two outer loop circuit layers 111a and one inner loop circuit layer 111b. However, in other embodiments, the power inductor 100 may exclude the inner loop circuit layer 111b, so that the quantity of the circuit layers included in the power inductor 100 is two, namely, two outer loop circuit layers 111a. Thus, the inner loop circuit layer 111b in FIG. 1C may be omitted.

Accordingly, the power inductor 100 in this embodiment is not limited to including the inner loop circuit layer 111b. In addition, the power inductor 100 may have four or more than four circuit layers. The power inductor 100 may include the plurality of inner loop circuit layers 111b, so that the power inductor 100 of the embodiment is not limited to including only one inner loop circuit layer 111b.

It is worth mentioning that the power inductor 100 may further include a plurality of covering layers 140a and the covering layers 140b. These covering layers 140a and covering layers 140b separately cover two opposite sides of the induced magnetic element 120 and the coil 110 and directly touch the induced magnetic element 120. That is, the induced magnetic element 120 and the coil 110 are located between the covering layers 140a and the covering layers 140b. Thus, the covering layers 140a and the covering layers 140b may cover these outer loop circuit layers 111a and at least one insulation spacing layer 112 (e.g., the top insulation spacing layer 112 in FIG. 1G). In addition, it should be noted that the power inductor 100 shown in FIG. 1B is illustrated after the covering layers 140a and the covering layers 140b are removed.

FIG. 1D is a locally-magnified schematic cross-sectional view of the induced magnetic element in FIG. 1C. Referring to FIG. 1D, the induced magnetic element 120 includes a plurality of ferromagnetic particles (not denoted), and each of the ferromagnetic particles includes an iron-based alloy particle 121 and an insulation film 122 which encapsulates the iron-based alloy particle 121. The insulation film 122 may be an oxide film including silicon dioxides. Further, the insulation film 122 may be formed from the iron-based alloy particle 121. For example, the iron-based alloy particles 121 are disposed into a furnace full of oxygen, so that the surfaces of the iron-based alloy particles 121 are oxidized. Thus, the insulation films 122 are formed.

Since each iron-based alloy particle 121 is encapsulated by the insulation film 122, the conductivity of the induced magnetic element 120 reduces, that is, the insulation resistance of the induced magnetic element 120 increases. As a result, even though the induced magnetic element 120 includes the iron-based alloy particles 121 which are conductive, the conductivity of the induced magnetic element 120 is less than metals and even equal to insulators. Further, since the induced magnetic element 120 includes the plurality of iron-based alloy particles 121, the induced magnetic element 120 has ferromagnetism.

Consequently, when the current is transmitted through the outer loop circuit layers 111a and the inner loop circuit layer 111b in FIG. 1C, the current is not transmitted through the induced magnetic element 120 which has high resistance, and the induced magnetic element 120 may induce an induced magnetic field by the current transmitted through the outer loop circuit layers 111a and the inner loop circuit layer 111b, so as to achieve the effect of an inductor.

Referring to FIG. 1C, among those insulation spacing layers 112, only one insulation spacing layer 112 is disposed on one side of the outer loop circuit layers 111a. Each of the other insulation spacing layers 112 is disposed between the outer loop circuit layer 111a and the inner loop circuit layer 111b which are adjacent to each other. Thus, when the power inductor 100 is utilized in the circuit with high current and high voltage, such as the automobile circuit or the high power circuit for an electronic, the insulation spacing layers 112 between the outer loop circuit layer 111a and the inner loop circuit layer 111b which are adjacent to each other may effectively obstruct the current that penetrates the induced magnetic element 120, and thereby prevent from short circuit.

FIG. 1E is a locally-magnified schematic cross-sectional view of one of the insulation spacing layers 112 in FIG. 1C. Referring to FIG. 1E, each of the insulation spacing layers 112 includes a plurality of flake insulating particles 112p. Each of the flake insulating particles 112p has a long axis L1 and a short axis S1 which is orthogonal to the long axis L1, and the long axis L1 of a part of the flake insulating particles 112p is orthogonal to the thickness direction D1. For instance, the flake insulating particles 112p may be flakes, and a part of the flake insulating particles 112p are distributed in the insulation spacing layer 112 in a flake-stacked lamination.

It is worth mentioning, the flake insulating particles 112p lead to an orientating insulation of the insulation spacing layer 112. Specifically, since the long axis L1 is orthogonal to the thickness direction D1 which leads to the decrease of permeability in the thickness direction D1, the saturation magnetization of the insulation spacing layer 112 in the thickness direction D1 is hard to be reached. Furthermore, due to the result that the bulk density in the thickness direction D1 increases, the insulation of the insulation spacing layer 112 in the thickness direction D1 increases.

In addition, in some embodiments, the ratio of the long axis L1 and the short axis S1 may be larger than 1. For example, when the long axis L1 of the flake insulating particles 112p is between 2 μm and 20 μm, the short axis S1 may be between 1 μm and 5 μm. However, the ratio of the long axis L1 and the short axis S1 is not limited to these embodiments.

In the embodiment, the insulating particles with an average grain size (i.e., D50) 5 μm are milled into the flake insulating particles 112p by ball mill, such as the planetary ball mill. In some embodiments, the average thickness of the flake insulating particles 112p may be between 1 μm and 5 μm. The flake insulating particles 112p may include magnetic alloy materials, such as FeSiCr, FeSiAl or similar ferromagnetic alloys.

In the embodiment with the flake insulating particles 112p, the breakdown voltage of the insulation spacing layer 112 may be between 20 V/m and 50 MV/m. Furthermore, the bending strength of the insulation spacing layer 112 may be between 10 N and 20 N.

It should be noted that the covering layers 140a and the covering layers 140b are both insulating. For example, the covering layers 140a and the covering layers 140b may be formed of ceramics or other insulation materials. In addition, at least one of the materials included in the covering layers 140a and the covering layers 140b and the material included in the induced magnetic element 120 may be the same. That is, at least one of the covering layers 140a and the covering layers 140b may include the plurality of ferromagnetic particles in the induced magnetic element 120 (as shown in FIG. 1D). Thus, the conductivity of the covering layers 140a and the covering layers 140b are equal to insulators, that is, the covering layers 140a and the covering layers 140b are both insulating.

In one of the embodiments, the covering layers 140a, the covering layers 140b and the induced magnetic element 120 may have the ferromagnetic particles with identical dimensions. That is, the ferromagnetic particles in the covering layers 140a, the covering layers 140b and the induced magnetic element 120 have the same particle sizes (e.g., the radius) and are comprised of the same materials. As a result, no boundary is formed between the induced magnetic element 120 and any of the covering layers 140a and the covering layers 140b. In other words, when the covering layers 140a, the covering layers 140b and the induced magnetic element 120 have the ferromagnetic particles with identical dimensions, the boundaries between the induced magnetic element 120 and any of the covering layers 140a and the covering layers 140b are hardly to be observed even under an electron microscope, such as a transmission electron microscope (TEM).

However, in other embodiments, since the covering layers 140a and the covering layers 140b may be formed of ceramics or other insulation materials, the materials included in the covering layers 140a and the covering layers 140b may be different from the materials included in the induced magnetic element 120, so that the boundaries between the induced magnetic element 120 and any of the covering layers 140a and the covering layers 140b may be formed. These boundaries may be observed under an optical microscope or an electron microscope (such as TEM).

Furthermore, even though the covering layers 140a, the covering layers 140b and the induced magnetic element 120 have the ferromagnetic particles formed of identical materials, the boundaries between the induced magnetic element 120 and any of the covering layers 140a and the covering layers 140b may still be formed. Specifically, when the ferromagnetic particles in the covering layers 140a, the covering layers 140b and the induced magnetic element 120 have substantially different particle sizes, the boundaries between the induced magnetic element 120 and any of the covering layers 140a and the covering layers 140b are formed. For example, when the particle size of the ferromagnetic particles in the induced magnetic element 120 differs from the averaged particle size (D50) of the ferromagnetic particles in the covering layers 140a and the covering layers 140b by 2 μm or more than 2 μm, the boundaries between the induced magnetic element 120 and any of the covering layers 140a and the covering layers 140b are formed.

FIG. 1F is a locally-magnified schematic cross-sectional view of the covering layer 140a and the covering layer 140b in FIG. 1C. Referring to FIG. 1F of one embodiment, each of the covering layer 140a and the covering layer 140b includes a plurality of flake insulating particles 142p. Each of the flake insulating particles 142p has a long axis L2 and a short axis S2 which is orthogonal to the long axis L2, and the long axis L2 of a part of the flake insulating particles 142p is orthogonal to the thickness direction D1. For instance, the flake insulating particles 142p may be flakes, and a part of the flake insulating particles 142p are distributed in the covering layer 140a and the covering layer 140b in a flake-stacked lamination. It is worth mentioning, in the embodiment, the flake insulating particles 112p of the insulation spacing layers 112 may include ceramic materials, while the flake insulating particles 142p of the covering layer 140a and the covering layer 140b may include magnetic alloy materials.

FIG. 1G is a schematic cross-sectional view along with the line 1G-1G of FIG. 1A. Referring to FIG. 1A and FIG. 1G, the induced magnetic element 120 exposes each of the outer connection ends Pa1 of the outer loop circuit layers 111a, so that the external electrodes 130 are connected to the outer connection ends Pa1. Specifically, in the embodiment shown in FIG. 1G, two opposite side surfaces of the induced magnetic element 120 (e.g., the left surface and the right surface) expose the sides of the outer connection ends Pa1, while the external electrodes 130 cover the aforementioned opposite side surfaces of the induced magnetic element 120 separately. Thus, the external electrodes 130 may touch and be connected to the outer connection ends Pa1 corresponding to the external electrodes 130 separately, so that the external electrodes 130 may be electrically connected to the outer connection ends Pa1. Thereby, the power inductor 100 receives the external electricity through the external electrodes 130 to function.

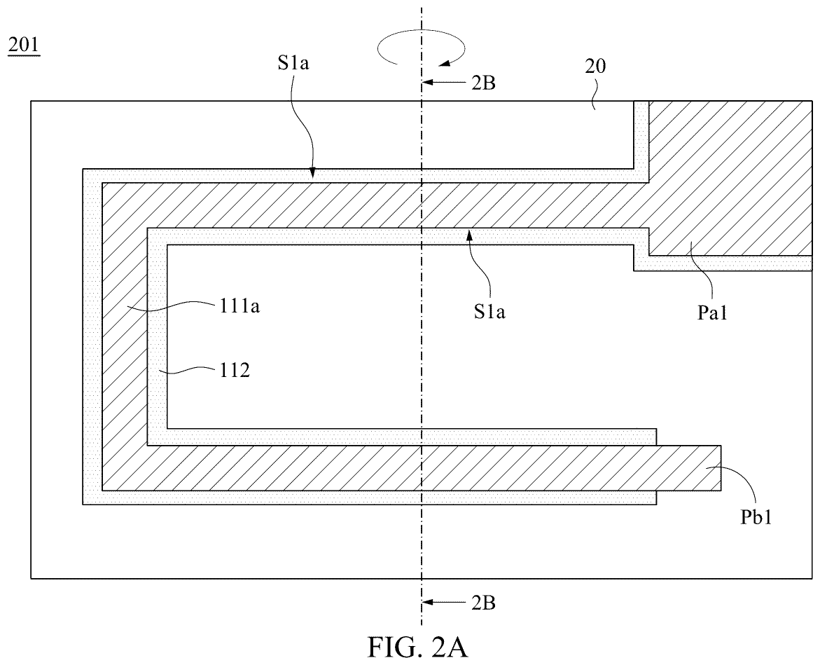

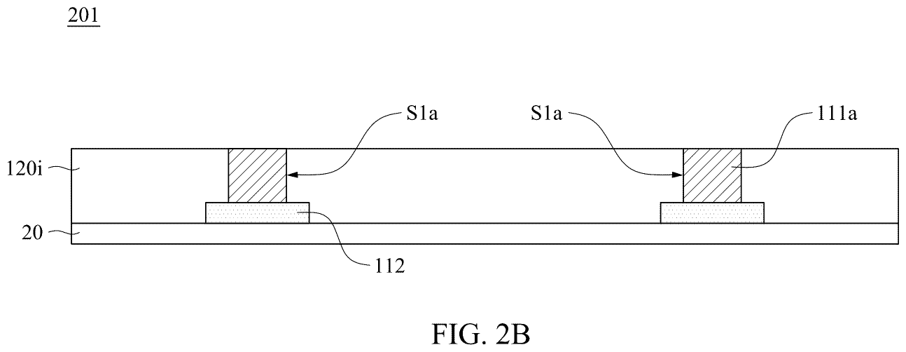

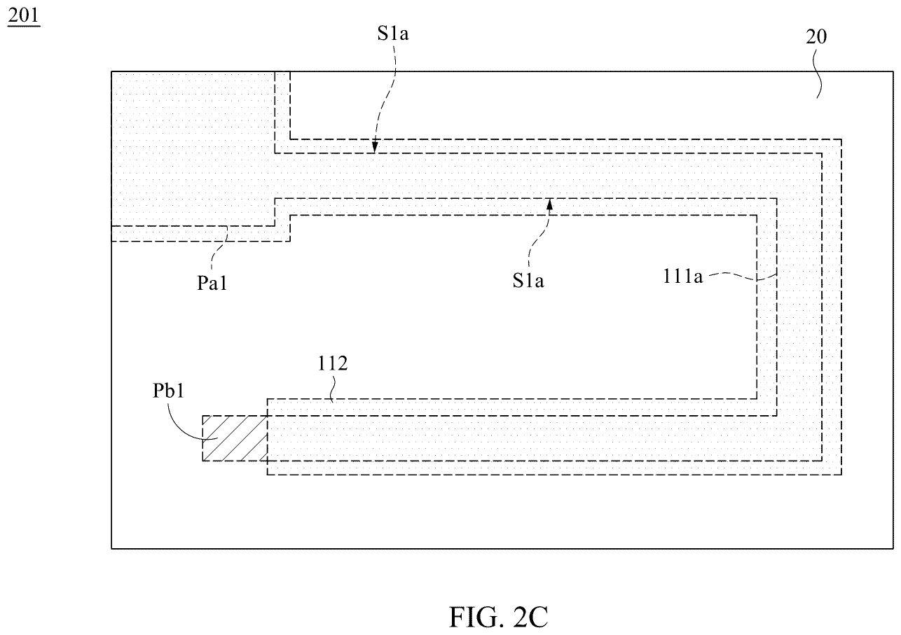

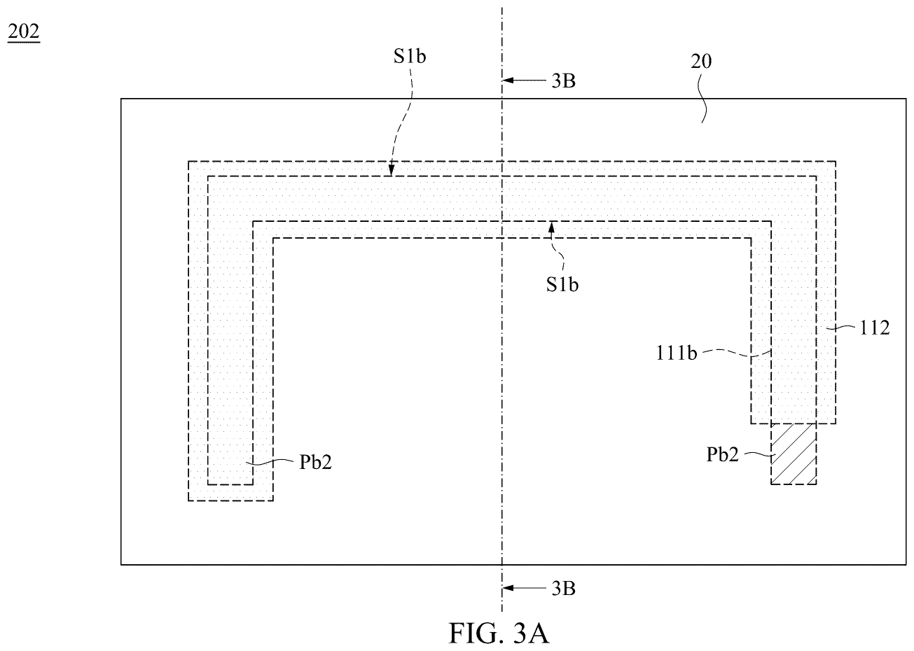

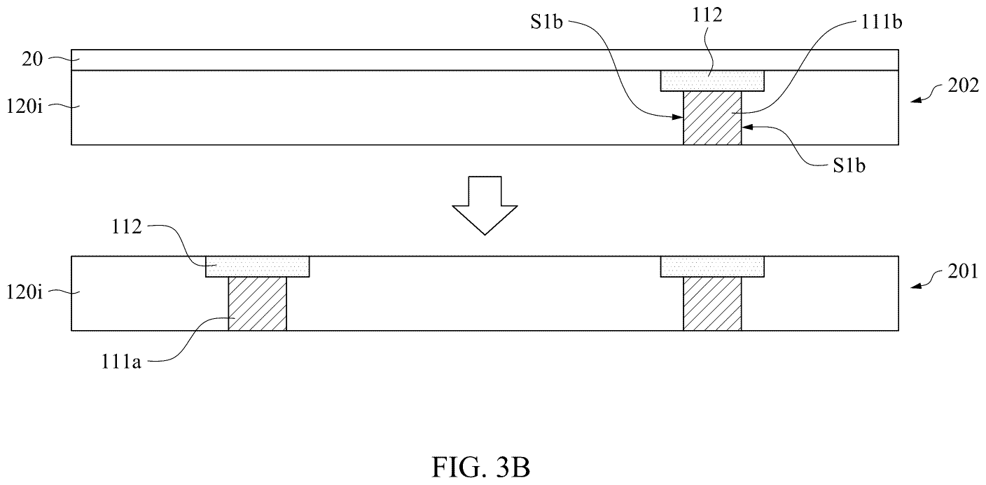

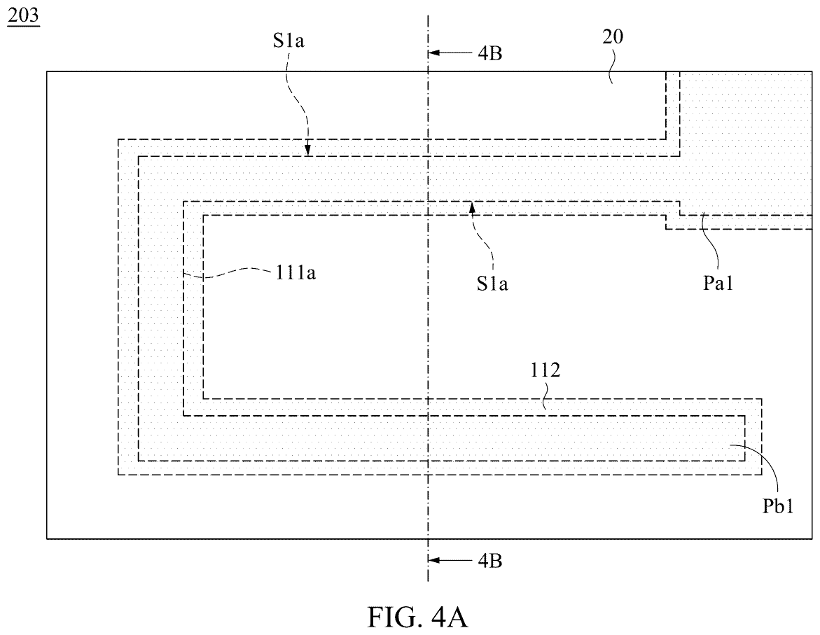

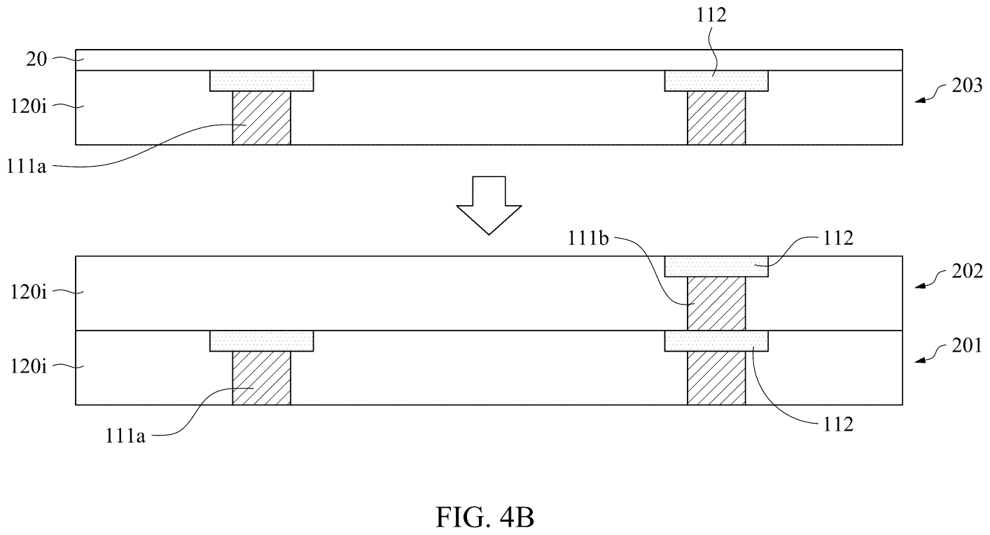

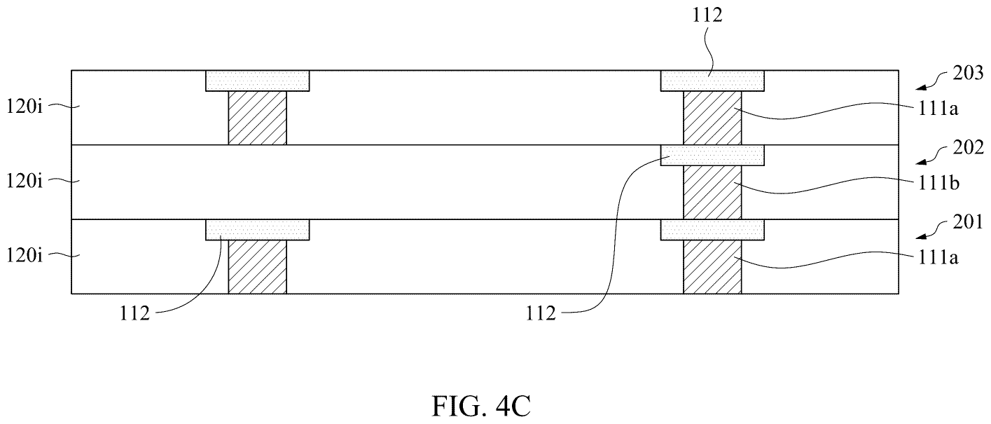

In the embodiment, the power inductor 100 is formed by the stacking and the lamination of a plurality of substrates, while each substrate has only one circuit layer. Thus, the aforementioned power inductor 100 with three circuit layers may be formed by stacking and lamination of three substrates. Take the power inductor 100 with three circuit layers (shown in FIG. 1C) for example, the method for fabricating the power inductor 100 is illustrated by FIG. 2A to FIG. 2C, FIG. 3A to FIG. 3B and FIG. 4A to FIG. 4C.

Referring to FIG. 2A to FIG. 20, the method for fabricating the power inductor 100 includes providing a first substrate 201. FIG. 2A is a schematic bottom view of the first substrate 201, while FIG. 2B is a schematic cross-sectional view along with the line 2B-2B of FIG. 2A. FIG. 2C is a schematic top view of the first substrate 201 and is an illustration of the first substrate 201 of revered FIG. 2A. The first substrate 201 includes a release layer 20, the outer loop circuit layer 111a and the insulation spacing layer 112 disposed between the release layer 20 and the outer loop circuit layer 111a.

In the method for fabricating the first substrate 201, firstly, the insulation spacing layer 112 and the outer loop circuit layer 111a are formed on the release layer 20 in sequence, and the materials of the release layer 20 may be organic materials, such as polyethylene terephthalate (PET). The insulation spacing layer 112 and the outer loop circuit layer 111a may be formed by printing, lithography, spray coating or deposition, and the deposition may be a physical vapor deposition (PVD) or a chemical vapor deposition (CVD). Next, an induced magnetic layer 120i which may be formed by printing, lithography or spray coating is formed on the release layer 20.

The outer loop circuit layer 111a is a strip in shape of reversed “C” as shown in FIG. 2C. The outer loop circuit layer 111a has the outer connection end Pa1 and a first inner connection end Pb1 opposite to the outer connection end Pa1, while the outer connection end Pa1 and the first inner connection end Pb1 are two opposite ends of the outer loop circuit layer 111a. The outer connection end Pa1 of the first substrate 201, which is in the left of FIG. 1B, is covered by the insulation spacing layer 112. The insulation spacing layer 112 extends along with the outer loop circuit layer 111a, so that the insulation spacing layer 112 is also a strip which is similar to the outer loop circuit layer 111a, namely, in shape of reversed “C”.

However, in other embodiments, each of the outer loop circuit layers 111a may not be located between the insulation spacing layers 112 which are adjacent to each other. For instance, the top insulation spacing layer 112 may be omitted in FIG. 1C. The outer loop circuit layer 111a has a pair of first side walls S1a which are opposite to each other, and the insulation spacing layer 112 that extends along with the outer loop circuit layer 111a protrudes from this pair of first side walls S1a, where the insulation spacing layer 112 directly touches the outer loop circuit layer 111a. Furthermore, the first inner connection end Pb1 of the outer loop circuit layer 111a protrudes from the end of the insulation spacing layer 112, so that the first inner connection end Pb1 may not be covered by the insulation spacing layer 112 completely and directly touch the release layer 20, as shown in FIG. 2A to FIG. 2C.

Referring to FIG. 3A and FIG. 3B, next, a second substrate 202 is provided, and the second substrate 202 is stacked and laminated on the first substrate 201. The release layer 20 on the first substrate 201 is removed before the second substrate 202 is stacked and laminated on the first substrate 201, so as to expose the insulation spacing layer 112 and the induced magnetic layer 120i of the first substrate 201. In addition, FIG. 3A is a schematic top view of the second substrate 202, while FIG. 3B illustrates a schematic cross-sectional view of the second substrate 202 stacked and laminated on the first substrate 201. The second substrate 202 in FIG. 3B is illustrated as a cross sectional view along with the line 3B-3B of FIG. 3A.

The structure of the second substrate 202 is similar to the structure of the first substrate 201. Specifically, the second substrate 202 includes the release layer 20, the inner loop circuit layer 111b and the insulation spacing layer 112 located between the release layer 20 and the inner loop circuit layer 111b. The materials of the inner loop circuit layer 111b and the outer loop circuit layer 111a may be the same. One of a second inner connection ends Pb2 in the inner loop circuit layer 111b protrudes from the end of the insulation spacing layer 112, while the other one of the second inner connection ends Pb2 is covered by the insulation spacing layer 112 as shown in FIG. 3A. Thus, the second inner connection end Pb2 is not completely covered by the insulation spacing layer 112 and directly touches the release layer 20.

Furthermore, the inner loop circuit layer 111b is a strip in shape of opposite “U”, and the inner loop circuit layer 111b has two second inner connection ends Pb2 opposite to each other, while these second inner connection ends Pb2 are two opposite ends of the inner loop circuit layer 111b. The insulation spacing layer 112 of the second substrate 202 directly touches the inner loop circuit layer 111b and extends along with the inner loop circuit layer 111b, so that the insulation spacing layer 112 is also a strip in shape of opposite “U”. The inner loop circuit layer 111b has a pair of second side walls S1b which are opposite to each other, and the insulation spacing layer 112 that extends along with the inner loop circuit layer 111b protrudes from this pair of second side walls S1b.

Referring to FIG. 2C and FIG. 3A, during the process of stacking and laminating the second substrate 202 on the first substrate 201, the first substrate 201 (shown in FIG. 2C) is located below, while the second substrate 202 (shown in FIG. 3A) is located above. As shown in FIG. 3A and FIG. 20, the left second inner connection end Pb2 of the upper inner loop circuit layer 111b aligns with the first inner connection end Pb1 of the lower outer loop circuit layer 111a. The aforementioned left second inner connection end Pb2 overlaps the insulation spacing layer 112 and does not protrude from the edge of the insulation spacing layer 112.

Since the first inner connection end Pb1 of the lower outer loop circuit layer 111a protrudes from the end of the insulation spacing layer 112, the first inner connection end Pb1 is exposed after the release layer 20 of the first substrate 201 is removed. Furthermore, since the upper second inner connection end Pb2 aligns with the lower first inner connection end Pb1, the upper second inner connection end Pb2 may directly touch and be connected to the lower first inner connection end Pb1 when the second substrate 202 is stacked and laminated on the first substrate 201, so that the outer loop circuit layer 111a and the inner loop circuit layer 111b may be electrically connected to each other.

During the process of stacking and laminating the second substrate 202 on the first substrate 201, the second substrate 202 and the first substrate 201 are heated up and pressed, so as to laminate the second substrate 202 on the first substrate 201. However, since the heating temperature is around 90° C., which is not high enough to fuse and merge the induced magnetic layer 120i of the second substrate 202 and the first substrate 201. That is, the boundaries between the second substrate 202 and the first substrate 201 still exist.

Referring to FIG. 4A and FIG. 4B, after the second substrate 202 is stacked and laminated on the first substrate 201, a third substrate 203 is provided, and the third substrate 203 is stacked and laminated on the second substrate 202. The release layer 20 on the second substrate 202 is removed before the third substrate 203 is stacked and laminated on the second substrate 202, so as to expose the insulation spacing layer 112 and the induced magnetic layer 120i of the second substrate 202. In addition, FIG. 4A is a schematic top view of the third substrate 203, while FIG. 4B illustrates a schematic cross-sectional view of the third substrate 203 stacked and laminated on the second substrate 202. The third substrate 203 in FIG. 4B is illustrated as a cross-sectional view along with the line 4B-4B of FIG. 4A.

The third substrate 203 includes the release layer 20, the outer loop circuit layer 111a and the insulation spacing layer 112 located between the release layer 20 and the outer loop circuit layer 111a. The structure of the third substrate 203 is similar to the structure of the first substrate 201, and the method for fabricating the third substrate 203 and the first substrate 201 are the same. For instance, in the third substrate 203, the outer loop circuit layer 111a and the insulation spacing layer 112 are both strips. The insulation spacing layer 112 extends along with the outer loop circuit layer 111a and directly touches the outer loop circuit layer 111a, while the insulation spacing layer 112 protrudes from the pair of the first side walls S1a of the outer loop circuit layer 111a. Furthermore, the outer loop circuit layer 111a also has the outer connection end Pa1 and the first inner connection end Pb1.

According to illustrations of FIG. 2A to FIG. 2C and FIG. 3A to FIG. 3B, two insulation spacing layers 112 which separately extend along with the outer loop circuit layer 111a protrude from the first side walls S1a of the outer loop circuit layer 111a separately, while two insulation spacing layers 112 which separately extend along with the inner loop circuit layer 111b protrude from the second side walls S1b of the inner loop circuit layer 111b separately. Thus, the insulation spacing layers 112 may increase the insulation resistance between the outer loop circuit layer 111a and the inner loop circuit layer 111b, and thereby prevent from short circuit.

Each of the insulation spacing layers 112 is a strip. Two of these insulation spacing layers 112 separately cover and directly touch the outer loop circuit layer 111a, while the other insulation spacing layers 112 cover and directly touch the inner loop circuit layer 111b. In addition, the first inner connection end Pb1 of each outer loop circuit layer 111a is connected to the second inner connection end Pb2 of one inner loop circuit layer 111b.

The primary difference between the third substrate 203 and the first substrate 201 is that the shapes of the outer loop circuit layer 111a and the insulation spacing layer 112 between these two substrates are different. The outer loop circuit layer 111a of the first substrate 201 is in shape of reversed “C” (as shown in FIG. 2C), while the outer loop circuit layer 111a of the third substrate 203 is in shape of “C” (as shown in FIG. 4A). Furthermore, the outer connection end Pa1 of the third substrate 203 is namely the outer connection end Pa1 located in the right of FIG. 1B.

Referring to FIG. 3A and FIG. 4A, during the process of stacking and laminating the third substrate 203 on the second substrate 202, the second substrate 202 (as shown in FIG. 3A) is located below, while the third substrate 203 (as shown in FIG. 4A) is located above. According to FIG. 3A and FIG. 4A, the first inner connection end Pb1 of the upper outer loop circuit layer 111a aligns with the right second inner connection end Pb2 of the lower inner loop circuit layer 111b, while the first inner connection end Pb1 overlaps the insulation spacing layer 112 and does not protrude from the edge of the insulation spacing layer 112.

Since the right second inner connection end Pb2 of the lower inner loop circuit layer 111b protrudes from the end of the insulation spacing layer 112, the right second inner connection end Pb2 is exposed after the release layer 20 of the second substrate 202 is removed. Furthermore, since the upper first inner connection end Pb1 aligns with the lower right second inner connection end Pb2, the upper first inner connection end Pb1 may directly touch and be connected to the lower second inner connection end Pb2 when the third substrate 203 is stacked and laminated on the second substrate 202, so that the outer loop circuit layer 111a and the inner loop circuit layer 111b may be electrically connected to each other.

Accordingly, due to the direct touch and connection between the first inner connection end Pb1 and the second inner connection end Pb2, the outer loop circuit layer 111a of the first substrate 201 and the third substrate 203 may be electrically connected to the inner loop circuit layer 111b of the second substrate 202. In addition, according to FIG. 2C, FIG. 3A and FIG. 4A, after the outer loop circuit layer 111a of the first substrate 201 and the third substrate 203 are electrically connected to the inner loop circuit layer 111b of the second substrate 202, the inner loop circuit layer 111b and the outer loop circuit layer 111a may form the spiral coil 110.

Referring to FIG. 4C, after the third substrate 203 is stacked and laminated on the second substrate 202, the first substrate 201, the second substrate 202 and the third substrate 203 connected to each other are burned out and sintered in sequence, so as to remove the organic materials remaining in the first substrate 201, the second substrate 202 and the third substrate 203. Thus, the induced magnetic layer 120i of the first substrate 201, the second substrate 202 and the third substrate 203 are consolidated, so that the induced magnetic element 120 (as shown in FIG. 1C) is formed. The insulation films 122 in the induced magnetic element 120 are connected to each other due to the sintering as shown in FIG. 1D. The process of the sintering may include introducing oxygen, so as to help the surfaces of the iron-based alloy particles 121 (as shown in FIG. 1D) to oxidize and to improve the insulation resistance of the induced magnetic element 120. The sintering temperature may be lower than 800° C.

Referring to FIG. 4C and FIG. 1C, the covering layers 140a and the covering layers 140b may separately be formed on two opposite sides of the induced magnetic element 120, such as on the upper surface of the third substrate 203 and the lower surface of the first substrate 201. When the materials included in the covering layers 140a and the covering layers 140b are different from the materials included in the induced magnetic element 120, the covering layers 140a and the covering layers 140b may be formed after the burnout and the sintering. When the materials included in the covering layers 140a and the covering layers 140b are the same as the materials included in the induced magnetic element 120, the covering layers 140a and the covering layers 140b may be separately formed on the upper surface of the third substrate 203 and the lower surface of the first substrate 201 before the burnout and the sintering.

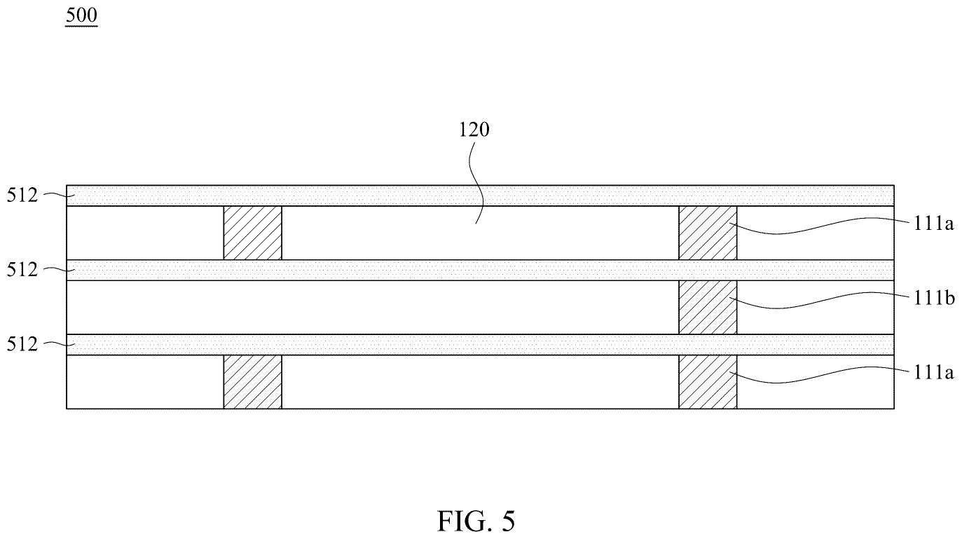

FIG. 5 is a schematic cross-sectional view of a power inductor in accordance with another embodiment of the present disclosure. Referring to FIG. 5, the power inductor 500 in FIG. 5 is similar to the aforementioned power inductor 100, while the power inductor 500 and the power inductor 100 include some identical components, such as the induced magnetic element 120, the outer loop circuit layer 111a and the inner loop circuit layer 111b. In addition, the power inductor 500 may include the external electrodes 130, the covering layers 140a and the covering layers 140b which are not illustrated in FIG. 5. Only the differences between the power inductor 500 and the power inductor 100 are explained as follows, and those identical features will not be repeated herein.

Differed from the power inductor 100, the power inductor 500 includes a plurality of insulation spacing layers 512, while each of the insulation spacing layers 512 protrudes from the edge in any one of the outer loop circuit layer 111a and the inner loop circuit layer 111b. Take FIG. 5 for example, each insulation spacing layer 512 extends to the side of the induced magnetic element 120 and overlaps the upper surface and the lower surface of the induced magnetic element 120 completely, so that the insulation spacing layer 512 protrudes from the edge of any one, or even both, of the outer loop circuit layer 111a and the inner loop circuit layer 111b, or the insulation spacing layer 512 is formed as a closed loop. Therefore, the insulation resistance of the insulation spacing layers 512 may significantly increase, so as to prevent the short circuit between the outer loop circuit layer 111a and the inner loop circuit layer 111b which are adjacent to each other.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A power inductor, comprising:
a coil, comprising:
two outer loop circuit layers stacked up and electrically connected to each other in a thickness direction, wherein each of the outer loop circuit layers has an outer connection end;
a plurality of insulation spacing layers, wherein at least one of the insulation spacing layers is located between the outer loop circuit layers, and each of the plurality of insulation spacing layers comprises:
a plurality of first flake insulating particles, and each of the plurality of first flake insulating particles has a first long axis and a first short axis orthogonal to the first long axis, wherein the first long axis of a part of the plurality of first flake insulating particles are orthogonal to the thickness direction;
an induced magnetic element encapsulating the coil and exposing the outer connection end of each of the outer loop circuit layers, wherein the induced magnetic element has a plurality of ferromagnetic particles, and each of the ferromagnetic particles comprises:
an iron-based alloy particle; and
an insulation film covering the iron-based alloy particle.

2. The power inductor of claim 1, wherein a ratio of the first long axis and the first short axis of the plurality of first flake insulating particles is larger than 1.

3. The power inductor of claim 1, wherein an average thickness of the plurality of first flake insulating particles is between 1 um and 5 um.

4. The power inductor of claim 1, wherein the plurality of first flake insulating particles comprise a magnetic alloy material.

5. The power inductor of claim 1, wherein a breakdown voltage of the plurality of first flake insulating particles is between 20 MV/m and 50 MV/m.

6. The power inductor of claim 1, wherein a bending strength of the plurality of first flake insulating particles is between 10 N and 20 N.

7. The power inductor of claim 1, comprising:
two covering layers covering two opposite side of the induced magnetic element and the coil separately, and the covering layers directly touch the induced magnetic element, and each of the covering layers comprises:
a plurality of second flake insulating particles, and each of the plurality of second flake insulating particles has a second long axis and a second short axis orthogonal to the second long axis, wherein the second long axis of a part of the plurality of second flake insulating particles are orthogonal to the thickness direction.

8. The power inductor of claim 7, wherein the plurality of first flake insulating particles of the plurality of insulation spacing layers comprise a ceramic material, and the plurality of second flake insulating particles of the covering layers comprise a magnetic alloy material.

9. The power inductor of claim 1, wherein one of the outer loop circuit layers is located between two insulation spacing layers adjacent to each other.

10. The power inductor of claim 1, further comprising:
a plurality of external electrodes partially covering an outer surface of the induced magnetic element and connected to the outer connection ends of the outer loop circuit layers.

11. The power inductor of claim 1, wherein the coil further comprises:
an inner loop circuit layer disposed between the outer loop circuit layers and electrically connected to the outer loop circuit layers, wherein the inner loop circuit layer is located between two of the insulation spacing layers.

12. The power inductor of claim 11, wherein each of the outer loop circuit layers has a first inner connection end opposite to the outer connection end, and the inner loop circuit layer has two second inner connection ends opposite to each other, wherein the first inner connection end of each of the outer loop circuit layers is connected to one of the second inner connection ends.

13. The power inductor of claim 12, wherein each of the insulation spacing layers is a strip, and two of the insulation spacing layers cover and directly touch the outer loop circuit layers and extend along with the outer loop circuit layers separately,
wherein each of the insulation spacing layers has a pair of first side walls opposite to each other, and the two of the insulation spacing layers separately extending along with the outer loop circuit layers protrude from the first side walls of the outer loop circuit layers separately.

14. The power inductor of claim 13, wherein the first connection end of one of the outer loop circuit layers protrudes from an end of one of the insulation spacing layers.

15. The power inductor of claim 13, wherein one of the insulation spacing layer directly touches and extends along with the inner loop circuit layer,
wherein the inner loop circuit layer has a pair of second side walls opposite to each other, and the insulation spacing layer extending along with the inner loop circuit layer protrudes from the second side walls.

16. The power inductor of claim 15, wherein one of the second inner connection ends of the inner loop circuit layer protrudes from the end of the insulation spacing layer extending along with the inner loop circuit layer.

17. The power inductor of claim 15, wherein each of the insulation spacing layers protrudes from an edge of any one of the outer loop circuit layers.
